(19) United States
(12) Patent Application Publication
(10) Pub. No.: US 2023/0068427 A1
(43) Pub. Date: Mar. 2, 2023

(54) Hard Coating Composition for Flexible Window Cover Film, Hard Coating Layer Obtained Therefrom, and Flexible Window Cover Film Including the Same

(71) Applicants: SK Innovation Co., Ltd., Seoul (KR); SK ie technology Co., Ltd., Seoul (KR)

(72) Inventors: Keon Hyeok Ko, Daejeon (KR); Byoung Sun Ko, Daejeon (KR); Hye Jin Kim, Daejeon (KR); Jeong Min Choi, Daejeon (KR); A Ran Hwang, Daejeon (KR)

(21) Appl. No.: 17/894,223

(22) Filed: Aug. 24, 2022

(30) Foreign Application Priority Data
Aug. 25, 2021 (KR) 10-2021-0112352

(51) Int. Cl. C08J 7/046; C08G 77/14; C08K 3/22; C08K 3/36; C08K 9/06

(52) U.S. Cl. CPC C08J 7/046; C08G 77/14; C08K 3/22; C08K 3/36; C08K 9/06; C08K 2003/2227; C08K 2201/003; C08K 2201/011

(57) ABSTRACT

Provided are a hard coating composition for a flexible window cover film, a hard coating layer obtained therefrom, and a flexible window cover film including the same. More particularly, a hard coating composition for a flexible window cover film which includes a high molecular weight epoxy polysiloxane resin, thereby satisfying surface properties such as excellent hardness, wear resistance, scratch resistance, and pressing resistance, and also having excellent flexibility so as to be appropriate for use in a flexible display panel, a hard coating layer obtained therefrom, and a flexible window cover film including the same.

### CROSS-REFERENCE TO RELATED APPLICATION

This application claims priority to Korean Patent Application No. 10-2021-0112352, filed Aug. 25, 2021, the disclosure of which is hereby incorporated by reference in its entirety.

### BACKGROUND OF THE INVENTION

### Field of the Invention

The present embodiment relates to a hard coating composition for a flexible window cover film, a hard coating layer obtained therefrom, and a flexible window cover film including the same.

### Description of Related Art

Recently, thin displays using a flat panel display such as a liquid crystal display or an organic light emitting diode display are drawing a lot of attention. In particular, these thin displays are implemented in the form of a touch screen panel, and are widely used in various smart devices characterized by their portability including various wearable devices as well as smart phones and tablet PCs.

These portable touch screen panel-based displays are provided with a window cover for display protection on a display panel in order to protect the display panel from scratches or external impact, and in most cases, a tempered glass for a display is used as a window cover.

However, the tempered glass is unsuitable for weight reduction of portable devices due to its heavy weight, is vulnerable to external shock so that it is difficult to implement a characteristic of not being easily broken, and does not bend beyond a certain level so that the tempered glass is unsuitable as a flexible display material having a bendable or foldable function.

Recently, various studies on an optical plastic cover securing flexibility and impact resistance while also having strength or scratch resistance corresponding to tempered glass have been conducted. However, a polymer plastic substrate shows insufficient physical properties in terms of hardness and scratch resistance and also has insufficient impact resistance, as compared with a tempered glass used as a window cover for display protection. Thus, various attempts for complementing durability by coating the plastic substrate with a composite resin composition, have been made.

In particular, recently, in order to complement the durability of the polymer plastic substrate, a plurality of window cover films on which a high-hardness hard coating layer to which a high molecular weight siloxane resin is applied is formed are known, but in the case, flexibility of a film is greatly deteriorated, so that it is not appropriate for use in a flexible display panel.

Accordingly, it is necessary to develop a new hard coating layer, which may have improved surface characteristics such as pencil hardness, indentation hardness, and elastic recovery rate, maintain excellent physical properties such as wear resistance, scratch resistance, and compression resistance, and also, implement excellent flexibility so as to be used in a flexible display panel, and a flexible window cover film including the same.

### SUMMARY OF THE INVENTION

One embodiment is directed to providing a hard coating composition for a flexible window cover film which may form a hard coating layer satisfying both high hardness and excellent flexibility.

Another embodiment is directed to providing a hard coating layer for a flexible window cover film which is formed from the hard coating composition for a flexible window cover film, and has excellent physical properties such as pencil hardness, indentation hardness, elastic recovery rate, and bending resistance.

Another embodiment is directed to providing a flexible window cover film including the hard coating layer.

Still another embodiment is directed to providing a flexible display panel using the flexible window cover film.

In one general aspect, a hard coating composition for a flexible window cover film includes: an epoxy polysiloxane resin including a unit represented by the following Chemical Formula 1:

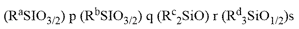

wherein R^{a} is an alicyclic epoxy group or an alkyl group substituted by an alicyclic epoxy group, R^{b} is any one group (functional group) selected from a glycidyl group, an alkyl group, an alkenyl group, an alkynyl group, an acryl group, a methacryl group, and an aryl group, or an alkyl group substituted by any one or two or more groups selected from those groups, and R^{c} and R^{d} are independently of each other any one group (functional group) selected from an alicyclic epoxy group, a glycidyl group, an alkyl group, an alkenyl group, an alkynyl group, an acryl group, a methacryl group, and an aryl group, or an alkyl group substituted by any one or two or more groups selected from those groups,

the substituted alkyl group may have a functional group which is any one selected from an amino group, a halogen, a mercapto group, an ether group, an ester group, a carbonyl group, a carboxyl group, a nitro group, a sulfone group, a hydroxyl group, a urethane group, and oxetane group, or a combination thereof,

$$0.9 \leq \text{p+q <1,}$$

$$0 \text{< r} \leq \text{0} \text{.1, and}$$

$$\text{0} \leq \text{s} \leq \text{0} \text{.05} \text{.}$$

In one exemplary embodiment, in Chemical Formula 1, p may be 0.5 or more and less than 1, and q may be more than 0 and 0.49 or less.

In one exemplary embodiment, the epoxy polysiloxane resin including a unit represented by the following Chemical Formula 1 may satisfy:

$$0.95 \leq \text{p+q <1, and}$$

$$0 \text{< r} \leq \text{0} \text{.05} \text{.}$$

In one exemplary embodiment, the epoxy polysiloxane resin may have a weight average molecular weight (Mw) of 2,000 to 40,000 g/mol.

In one exemplary embodiment, the hard coating composition may further include an epoxy compound having an alicyclic epoxy group.

In one exemplary embodiment, the epoxy compound may have an epoxy equivalent of 150 g/eq or less.

In one exemplary embodiment, the epoxy compound may be a compound represented by the following Chemical Formula 2 or 3:

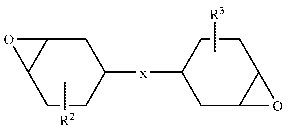

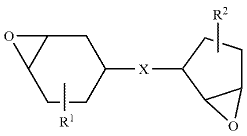

wherein R¹ and R² may be independently of each other hydrogen; or a linear or branched alkyl group having 1 to 5 carbon atoms, and X may be a direct bond; a carbonyl group; a carbonate group; an ether group; a thioether group; an ester group; an arylene group; an amide group; a linear or branched alkylene group, alkylidene group, or alkoxylene group having 1 to 18 carbon atoms; a cycloalkylene group or a cycloalkylidene group having 3 to 6 carbon atoms; or a group formed by two or more selected therefrom being linked to each other.

In one exemplary embodiment, the epoxy compound may be included at 1 to 60 parts by weight with respect to 100 parts by weight of the epoxy polysiloxane resin.

In one exemplary embodiment, the hard coating composition may further include a photoinitiator and a thermal initiator including a compound represented by the following Chemical formula 6:

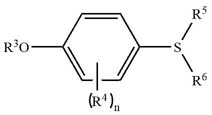

wherein R³ is hydrogen, an alkoxycarbonyl group having 1 to 4 carbon atoms, an alkylcarbonyl group having 1 to 4 carbon atoms, or an arylcarbonyl group having 6 to 14 carbon atoms, R⁴ is independently of each other hydrogen, a halogen, or an alkyl group having 1 to 4 carbon atoms, n is 1 to 4, R⁵ is an alkyl group having 1 to 4 carbon atoms or an aralkyl group having 7 to 15 carbon atoms which may be substituted by an alkyl group having 1 to 4 carbon atoms, R⁶ is an alkyl group having 1 to 4 carbon atoms, and X is SbF₆, PF₆, AsF₆, BF₄, CF₃SO₃, N(CF₃SO₂)₂, or N(C₆F₅)₄.

In one exemplary embodiment, the hard coating composition may further include inorganic particles which are any one selected from inorganic nanoparticles and surface-treated inorganic nanoparticles, or a mixture thereof.

In one exemplary embodiment, the inorganic particles may have an average particle diameter of 100 nm or less.

In one exemplary embodiment, the inorganic particles may be any one selected from silica and alumina, or a mixture thereof.

In one exemplary embodiment, the inorganic particles may be included at 0.01 to 10 parts by weight with respect to 100 parts by weight of the epoxy polysiloxane resin.

In another general aspect, a hard coating layer for a flexible window cover film, which has a pencil hardness of 4 H or more, an indentation hardness of 60 hv or more, an elastic recovery rate of 80% or more, and no crack occurrence when being repeatedly folded 200,000 times at a speed of 60 cycles/min at a folding radius of 3.5 R or less, according to a bending resistance test based on IEC 62715-6-1, is provided.

In one exemplary embodiment, the hard coating layer may be formed from the hard coating composition for a flexible window cover film described above.

In one exemplary embodiment, the hard coating layer may be formed by photocuring and thermal curing of the hard coating composition for a flexible window cover film.

In another general aspect, a flexible window cover film includes: a substrate; and a hard coating layer for a flexible window cover film described above formed on one or both surfaces of the substrate.

In still another general aspect, a flexible display panel includes the flexible window cover film described above.

Other features and aspects will be apparent from the following detailed description, the drawings, and the claims.

### DETAILED DESCRIPTION OF THE INVENTION

Hereinafter, a hard coating composition for a flexible window cover film, a hard coating layer obtained therefrom, and a flexible window cover film including the same according to one exemplary embodiment will be described in detail.

Herein, unless otherwise defined, all technical terms and scientific terms have the same meanings as those commonly understood by one of those skilled in the art. The terms used for description in the present exemplary embodiment are only for effectively describing certain specific examples, and are not intended to limit the present exemplary embodiment. Further, unless otherwise stated, the unit of added materials herein may be wt%.

In addition, the singular form used in the specification and claims appended thereto may be intended to also include a plural form, unless otherwise indicated in the context.

Throughout the specification describing the present exemplary embodiment, unless explicitly described to the contrary, “comprising” any constituent elements will be understood to imply further inclusion of other constituent elements rather than the exclusion of any other constituent elements.

Hereinafter, unless otherwise defined in the present specification, it will be understood that when a part such as a layer, a film, a thin film, a region, or a plate is referred to as being “on” or “above” another part, it may include not only the case of being “directly on” the other part but also the case of having an intervening part therebetween.

Hereinafter, unless otherwise defined in the present specification, a “combination thereof” refers to a mixture or copolymerization of constituents.

Hereinafter, unless otherwise particularly defined in the present specification, the term “A and/or B” may refer to an embodiment including both A and B or an embodiment selecting one of A and B.

Hereinafter, unless otherwise particularly defined in the present specification, “polymer” may include an oligomer and a polymer, and may include a homopolymer and a copolymer. The oligomer may refer to a case in which the number of repeating units is 2 to 20, and the copolymer may include an alternating polymer, a block copolymer, a random copolymer, a branch copolymer, a crosslinked copolymer, or a combination thereof.

Hereinafter, unless otherwise particularly defined, the term “flexible” may refer to warping, being bent, or being folded,

A window cover film including a hard coating layer having excellent surface properties such as hardness, wear resistance, and scratch resistance is required for protecting a flexible display panel from external shock.

A technology to apply a high molecular weight siloxane resin as a conventional hard coating layer for improving surface properties has been developed, but the flexibility is greatly deteriorated, so that it is not appropriate for use in protecting a flexible display panel.

Development of a new hard coating layer which maintains excellent surface properties such as hardness, wear resistance, and scratch resistance, has excellent flexibility which is in a trade-off relationship with the surface properties, and is appropriate for use in a flexible display panel, and a hard coating composition which may impart the properties, using a high molecular weight siloxane resin, is demanded.

A hard coating composition for a flexible window cover film according to one exemplary embodiment (hereinafter, also referred to as “hard coating composition”) is a hard coating composition for a flexible window cover film including an epoxy polysiloxane resin including a unit represented by the following Chemical Formula 1:

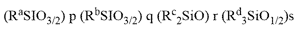

wherein R^{a} is an alicyclic epoxy group or an alkyl group substituted by an alicyclic epoxy group, R^{b} is any one group (functional group) selected from a glycidyl group, an alkyl group, an alkenyl group, an alkynyl group, an acryl group, a methacryl group, and an aryl group, or an alkyl group substituted by any one or two or more groups selected from those groups, and R^{c} and R^{d} are independently of each other any one group (functional group) selected from an alicyclic epoxy group, a glycidyl group, an alkyl group, an alkenyl group, an alkynyl group, an acryl group, a methacryl group, and an aryl group, or an alkyl group substituted by any one or two or more groups selected from those groups,

the substituted alkyl group may further include any one selected from an amino group, a halogen, a mercapto group, an ether group, an ester group, a carbonyl group, a carboxyl group, a nitro group, a sulfone group, a hydroxyl group, a urethane group, and oxetane group, or a combination thereof,

$$0.9 \leq \text{p+g} < \text{1,}$$

$$0 < \text{r} \leq \text{0} \text{.1,} \text{and}$$

$$0 \leq \text{s} \leq \text{0} \text{.05} \text{.}$$

The hard coating layer formed from the hard coating composition according to one exemplary embodiment is obtained by curing a composition including a high molecular weight epoxy polysiloxane resin, and may implement improved surface properties such as excellent hardness, wear resistance, scratch resistance, and pressing resistance and also have excellent flexibility to be appropriate for use in a flexible display panel.

In a more specific exemplary embodiment, in Chemical Formula 1, R^{a} may be an alicyclic epoxy group or a C1 to C20 alkyl group substituted by an alicyclic epoxy group, and more specifically, a (3,4-epoxycyclohexyl)methyl group, a (3,4-epoxycyclohexyl)ethyl group, a (3,4-epoxycyclohexyl)propyl group, and the like, but is not necessarily limited thereto.

In addition, R^{b} may be a glycidyl group or a C1 to C20 alkyl group substituted by a glycidyl group, and more specifically, a glycidyloxypropyl group and the like, but is not necessarily limited thereto.

In addition, R^{c} and R^{d} may be independently of each other any one group (functional group) selected from an alicyclic epoxy group, a glycidyl group, a C1 to C20 alkyl group, C2 to C20 alkenyl group, a C2 to C20 alkynyl group, an acryl group, a methacryl group, and a C6 to C20 aryl group, or a C1 to C20 alkyl group substituted by any one or two or more groups selected from the groups (functional groups), and the substituted alkyl group may have a functional group which is any one selected from an amino group, a halogen, a mercapto group, an ether group, an ester group, a carbonyl group, a carboxyl group, a nitro group, a sulfone group, a hydroxy group, a urethane group, and an oxetane group, or a combination thereof, but is not necessarily limited thereto. Specifically, R^{c} and R^{d} may be independently of each other a methyl group, an ethyl group, a (3,4-epoxycyclohexyl)methyl group, a (3,4-epoxycyclohexyl)ethyl group, a (3,4-epoxycyclohexyl)propyl group, a glycidyloxypropyl group, or the like, but is not necessarily limited thereto.

Specifically, in one exemplary embodiment, in Chemical Formula 1, the sum of p and q may satisfy 0.95 ≤ p+q <1, and r may satisfy 0 < r ≤ 0.05, but it not necessarily limited thereto. When the range is satisfied, a hard coating layer having further improved hardness, better bending resistance, and further improved flexibility may be implemented.

In one exemplary embodiment, in Chemical Formula 1, p may be 0.5 or more and less than 1, and q may be more than 0 and 0.49 or less, but it is not necessarily limited thereto. Specifically, p may be 0.5 to 0.98 and q may be 0.01 to 0.49, and more specifically p may be 0.8 to 0.98 and q may be 0.01 to 0.19, but it is not necessarily limited thereto.

When p and q of Chemical Formula 1 satisfy the above range, the content of the alicyclic epoxy group is increased to further improve the processability of the hard coating composition and further decrease oxygen sensitivity in a curing reaction. In addition, the hard coating layer formed therefrom may implement excellent surface properties such as higher pencil hardness, indentation hardness, and elastic recovery rate by more dense crosslinking, greatly improve wear resistance, scratch resistance, pressing resistance, and the like, and have further improved bending resistance to have better flexibility.

In one exemplary embodiment, the epoxy polysiloxane resin may be prepared by a hydrolysis reaction and a condensation reaction of a siloxane compound including a trialkoxysilane compound having an alicyclic epoxy group; a trialkoxysilane compound having a glycidyl group; and a dialkoxysilane compound having any one or two or more groups selected from an alicyclic epoxy group, a glycidyl group, an alkyl group, an alkenyl group, an alkynyl group, an acryl group, a methacryl group, and an aryl group in the presence of water and a catalyst, but it is not necessarily limited thereto.

Here, the catalyst may include, for example, an acid catalyst such as hydrochloric acid, acetic acid, hydrogen fluoride, nitric acid, sulfuric acid, chlorosulfonic acid, iodic acid, and phyllophosphoric acid; a base catalyst such as ammonia, potassium hydroxide, sodium hydroxide, barium hydroxide, and immidazole; and an ion exchange resin, and also may be selected from the group consisting of combinations thereof, but it is not necessarily limited thereto.

The hydrolysis reaction and the condensation reaction may be performed by stirring at room temperature for about 12 hours to 7 days, and more specifically, in order to promote the reaction, may be performed by stirring at room temperature for 2 hours to 72 hours, but are not necessarily limited thereto.

In one exemplary embodiment, the epoxy polysiloxane resin may have a weight average molecular weight (Mw) of 2,000 to 40,000 g /mol, specifically 6,000 to 40,000 g/mol, and more specifically 10,000 to 40,000 g/mol, but is not necessarily limited thereto. When the molecular weight of the epoxy polysiloxane resin satisfies the above range, the hard coating layer formed from the hard coating composition including the resin may have further improved surface properties such as high hardness, wear resistance, scratch resistance, and pressing resistance.

In one exemplary embodiment, the hard coating composition may further include an epoxy compound having an alicyclic epoxy group.

Specifically, in one exemplary embodiment, the epoxy compound may have an epoxy equivalent of 150 g/eq or less, more specifically 135 g/eq or less. For example, the epoxy compound may have an epoxy equivalent of 70 to 150 g/eq, specifically 70 to 135 g/eq, but is not necessarily limited thereto.

When the epoxy compound satisfying the epoxy equivalent range is combined with the epoxy polysiloxane resin described above, a reaction rate between the alicyclic epoxy group of the epoxy compound and the epoxy polysiloxane resin may be further improved, a curing rate is further increased, and an indentation hardness may be further improved, wear resistance, scratch resistance, pressing resistance, and the like may be further improved, while bending resistance and the like are further improved, thereby implementing a hard coating layer having better flexibility.

Specifically, in one exemplary embodiment, the epoxy compound may have two or more alicyclic epoxy groups, and more specifically, the epoxy compound may be a compound represented by the following Chemical Formula 2 or 3, but is not necessarily limited thereto:

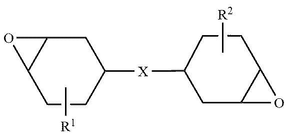

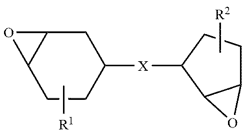

wherein R¹ and R² may be independently of each other hydrogen; or a linear or branched alkyl group having 1 to 5 carbon atoms, and X may be a direct bond; a carbonyl group; a carbonate group; an ether group; a thioether group; an ester group; an arylene group; an amide group; a linear or branched alkylene group, alkylidene group, or alkoxylene group having 1 to 18 carbon atoms; a cycloalkylene group or a cycloalkylidene group having 3 to 6 carbon atoms; or a group formed by two or more selected therefrom being linked to each other, but it is not necessarily limited thereto.

Herein, “direct bond” may refer to a structure which is directly bonded without other functional groups. For example, Chemical Formula 2 may refer to two cyclohexanes being directly connected, and this may be represented by the following Chemical Formula 4. In addition, Chemical Formula 3 may refer to cyclohexane and cyclopentane being directly connected, and this may be represented by the following Chemical Formula 5.

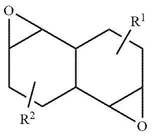

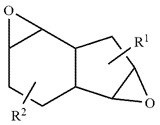

In addition, “two or more groups selected therefrom being connected to each other” may refer to two or more substituents described above being connected to each other. An example thereof may be an alkylene group connected by an ether group in which the ether group and the alkylene group are connected to each other.

In one exemplary embodiment, the content of the epoxy compound may be included at 1 to 60 parts by weight, more specifically 1 to 40 parts by weight with respect to 100 parts by weight of the epoxy polysiloxane resin, but is not necessarily limited thereto. Within the range, the coatability and the curing rate of the hard coating composition may be further improved, and the surface properties such as hardness, wear resistance, scratch resistance, and pressing resistance, and the flexibility of the hard coating layer formed therefrom may be further improved.

In one exemplary embodiment, the hard coating composition may further include a thermal initiator and a photoinitiator.

In one exemplary embodiment, the thermal initiator may include the following Chemical Formula 6:

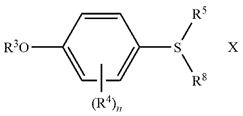

wherein R³ is hydrogen, an alkoxycarbonyl group having 1 to 4 carbon atoms, an alkylcarbonyl group having 1 to 4 carbon atoms, or an arylcarbonyl group having 6 to 14 carbon atoms, R⁴ is independently of each other hydrogen, a halogen, or an alkyl group having 1 to 4 carbon atoms, n is 1 to 4, R⁵ is an alkyl group having 1 to 4 carbon atoms or an aralkyl group having 7 to 15 carbon atoms which may be substituted by an alkyl group having 1 to 4 carbon atoms, R⁶ is an alkyl group having 1 to 4 carbon atoms, and X is SbF₆, PF₆, AsF₆, BF₄, CF₃SO₃, N(CF₃SO₂)₂, or N(C₆ F₅)₄.

The alkoxycarbonyl group has an alkoxy part having 1 to 4 carbon atoms, and may be, for example, a methoxycarbonyl group, an ethoxycarbonyl group, a propoxycarbonyl group, and the like.

The alkylcarbonyl group has an alkyl part having 1 to 4 carbon atoms, and may be, for example, an acetyl group, a propionyl group, and the like.

The arylcarbonyl group has an aryl part having 6 to 14 carbon atoms, and may be, for example, a benzoyl group, a 1-naphthylcarbonyl group, a 2-naphthylcarbonyl group, and the like.

The aralkyl group may be, for example, a benzyl group, a 2-phenylethyl group, a 1-naphthylmethyl group, a 2-naphthylmethyl group, and the like.

By using the compound of Chemical Formula 6 as the thermal initiator, a cure half-life may be shortened and thermal curing may be rapidly performed even in low-temperature conditions, and thus, damage and deformation due to a long-term heat treatment under high-temperature conditions may be prevented. In addition, the thermal initiator may further promote a crosslinking reaction of the epoxy polysiloxane resin when heat is applied to the hard coating composition.

In one exemplary embodiment, the thermal initiator may be included at 0.05 to 20 parts by weight, more specifically 0.1 to 20 parts by weight with respect to 100 parts by weight of the epoxy polysiloxane resin, but is not necessarily limited thereto. When the content of the thermal initiator is within the range, a thermal curing reaction may be performed at a more effective rate, and the phenomenon in which the content of other components of the hard coating layer composition is decreased to deteriorate the mechanical properties (e.g., hardness, flexibility, and the like) of the hard coating layer may be more prevented, but the content range is not necessarily limited thereto.

In one exemplary embodiment, the photoinitiator may include a photocationic initiator. The photocationic initiator may initiate a curing reaction of the hard coating composition including the epoxy polysiloxane resin and an epoxy-based monomer.

An example of the photocationic initiator may include an onium salt and/or an organic metal salt, but is not necessarily limited thereto, and for example, a diaryliondonium salt, a triarylsulfonium salt, an aryldiazonium salt, an iron-arene complex, and the like may be used, alone or in combination of two or more, but it is not necessarily limited thereto.

In one exemplary embodiment, the photoinitiator may be included at 0.1 to 15 parts by weight, more specifically 0.5 to 15 parts by weight with respect to 100 parts by weight of the epoxy polysiloxane resin, but is not necessarily limited thereto. When the content of the photoinitiator is within the above range, more excellent curing efficiency of the hard coating composition may be maintained, and deterioration of the physical properties due to residual components after curing may be more prevented.

In one exemplary embodiment, the hard coating composition may further include inorganic particles which are any one selected from inorganic nanoparticles and surface-treated inorganic nanoparticles, or a mixture thereof. The inorganic particles may further improve the hardness of the hard coating layer.

In one exemplary embodiment, the inorganic particles may be any one selected from metal particles of metal oxides such as silica, alumina, and titanium oxide; hydroxides such as aluminum hydroxide, magnesium hydroxide, and potassium hydroxide; and alloys including gold, silver, bronze, nickel, or two or more thereof; conductive particles such as carbon, carbon nanotubes, and fullerene; glass; ceramics; and the like, or a mixture thereof, and more specifically, may be any one selected from silica and alumina, or a mixture thereof, in terms of compatibility with other components of the hard coating composition, but are not necessarily limited thereto.

In one exemplary embodiment, the surface-treated inorganic nanoparticles may be those which are at least partially surface-treated with a silicone compound for mixing well with the epoxy polysiloxane resin.

In one exemplary embodiment, the inorganic particles may have a shape such as spherical, plate-shaped, and amorphous shapes, and have an average particle diameter of 100 nm or less, specifically 1 to 100 nm, and more specifically 1 to 50 nm, but are not necessarily limited thereto.

In one exemplary embodiment, the content of the inorganic particles may be 0.01 to 10 parts by weight, specifically 0.1 to 5 parts by weight, and more specifically 0.5 to 5 parts by weight with respect to 100 parts by weight of the epoxy polysiloxane resin, but is not necessarily limited thereto.

The hard coating layer formed from the hard coating composition including the inorganic particles satisfying the average particle diameter and the content range may have further improved surface properties such as hardness, wear resistance, scratch resistance, and pressing resistance, without affecting the surface roughness or the transparency of a film.

In one exemplary embodiment, the hard coating composition may further include a solvent. The solvent is not particularly limited and a solvent known in the art may be used.

A non-limiting example of the solvent may include alcohol-based solvents (methanol, ethanol, isopropanol, butanol, methyl cellosolve, ethyl cellosolve, and the like), ketone-based solvents (methyl ethyl ketone, methyl butyl ketone, methyl isobutyl ketone, diethyl ketone, dipropyl ketone, cyclohexanone, and the like), alkane-based solvents (hexane, heptane, octane, and the like), benzene-based solvents (benzene, toluene, xylene, and the like), and the like, and these may be used alone or in combination of two or more, but it is not necessarily limited thereto.

The content of the solvent may be 10 to 200 parts by weight with respect to 100 parts by weight of the epoxy polysiloxane resin, but is not necessarily limited thereto. When the range is satisfied, workability may be better, the thickness of the hard coating layer may be easily adjusted, and a solvent drying time is decreased to secure a rapid process speed, in forming the hard coating layer from the hard coating composition, but the content range is not necessarily limited thereto.

In one exemplary embodiment, the hard coating composition may further include a lubricant. The lubricant may improve winding efficiency, blocking resistance, wear resistance, scratch resistance, and the like.

The kind of lubricant may include wax such as polyethylene wax, paraffin wax, synthetic wax, or Montan wax; synthetic resins such as silicon-based resins and fluorine-based resins; and the like, and these may be used alone or in combination of two or more, but it is not necessarily limited thereto.

Besides, the hard coating composition may further include additives such as, for example, an antioxidant, a UV absorber, a photostabilizer, a thermal polymerization inhibitor, a leveling agent, a surfactant, a lubricant, and an antifouling agent.

Hereinafter, a flexible window cover film formed from the hard coating composition for a flexible window cover film described above (hereinafter, also referred to as a hard coating layer) as another exemplary embodiment will be described.

In one exemplary embodiment, the thickness of the hard coating layer may be 1 to 100 um, more specifically 1 to 50 µm, but is not necessarily limited thereto. When the thickness is within the range, the hard coating layer may implement more improved hardness and better flexibility, but it is not necessarily limited to the range.

In one exemplary embodiment, the hard coating layer may be formed by photocuring and thermal curing of the hard coating composition for a flexible window cover film described above. By using thermal curing using the thermal initiator and photocuring using the photoinitiator described above in combination, the curing degree, the hardness, and the flexibility of the hard coating layer may be further improved.

For example, the hard coating composition is applied to a substrate or the like and is irradiated with ultraviolet rays (photocuring) to at least partially cure the composition, and then heat is further applied (thermal curing), thereby substantially completely curing the composition. Otherwise, curing may be performed in a reverse order to the above description.

That is, the hard coating composition may be semi-cured or partially cured by the photocuring, and the semi-cured or partially cured hard coating composition may be substantially completely cured by the thermal curing.

For example, when the hard coating composition is cured only by the photocuring, a curing time is excessively extended or curing may not be completely performed in part. However, when the photocuring is followed by the thermal curing, the portion which is not cured by the photocuring may be substantially completely cured by the thermal curing, and the curing time may be also reduced.

In addition, generally, a portion which has been already appropriately cured is provided with excessive energy due to an increased curing time (for example, an increased light exposure time), which may cause overcuring. When the overcuring proceeds, the hard coating layer may lose flexibility or mechanical defects may occur. However, the photocuring and the thermal curing are used in combination, the hard coating composition may be substantially completely cured within a short time. Thus, the surface properties such as hardness, wear resistance, and scratch resistance may be further improved while excellent flexibility of the hard coating layer is implemented.

A method of photocuring the hard coating composition first and further thermally curing is described above, but an order of photocuring and thermal curing is not necessarily limited thereto, and the thermal curing may proceed first and then the photocuring may proceed later.

In one exemplary embodiment, the hard coating layer may satisfy the physical properties of a pencil hardness of 4H or more, an indentation hardness of 60 hv or more, and an elastic recovery rate of 80% or more, and also, has no crack when being repeatedly folded 200,000 times at a speed of 60 cycles/min at a folding radius of 3.5 R or less, according to a bending resistance test based on IEC 62715-6-1, so that the bending resistance is also significantly improved, and thus, both high hardness properties and excellent flexibility appropriate for use in a flexible display panel may be satisfied.

More specifically, in one exemplary embodiment, the hard coating layer may have a pencil hardness in accordance with JIS K5400 of 4 H or more, specifically 4 H to 9 H, and more specifically 5 H to 9 H.

In addition, in one exemplary embodiment, the hard coating layer may have an indentation hardness of 60 hv or more, specifically 70 hv or more, for example, 60 to 100 hv, and specifically, 70 to 100 hv.

In addition, in one exemplary embodiment, the hard coating layer may have an elastic recovery rate of 80% or more, 85% or more, for example, 80 to 99%, or 85 to 99%.

When all of the pencil hardness, the indentation hardness, and the elastic recovery rate satisfy the range, the hard coating layer may have improved surface properties such as better hardness, wear resistance, scratch resistance, and pressing resistance, and may prevent surface damage due to external shock more significantly.

In addition, in one exemplary embodiment, the hard coating layer may satisfy all of the ranges of the pencil hardness, the indentation hardness, and the elastic recovery rate, and may have no crack occurrence when being repeatedly folded 200,000 times at a speed of 60 cycles/min at a folding radius of 3.5 R or less, more specifically, 2.5R or less, according to a bending resistance test based on IEC 62715-6-1 to also have excellent bending resistance, and thus, implements surface properties such as excellent hardness, wear resistance, scratch resistance, and pressing resistance, while also having flexibility which is in a trade-off relationship with the surface properties. Thus, the hard coating layer may be more appropriate for use as a film for protecting a flexible display panel.

Therefore, the hard coating layer for a flexible window cover film according to one exemplary embodiment is formed using a high molecular weight siloxane resin to have excellent physical properties such as pencil hardness, surface hardness, and elastic recovery rate, and thus, has significantly improved surface properties such as hardness, wear resistance, scratch resistance, and pressing resistance, durability, impact resistance, and the like, while also implementing significantly improved bending resistance and flexibility, so that it is appropriate for use in a flexible display panel.

Another exemplary embodiment may provide a flexible window cover film including: a substrate; and a hard coating layer formed by applying the hard coating composition for a flexible window cover film on one or both surfaces of the substrate, and a method of manufacturing the same.

In one exemplary embodiment, the substrate may have excellent transparency, mechanical strength, thermal stability, moisture barrier properties, isotropy, and the like, and for example, may be manufactured from, for example, polyester-based resins such as polyethylene terephthalate, polyethylene isophthalate, and polybutylene terephthalate; cellulose-based resins such as diacetyl cellulose and triacetyl cellulose; polycarbonate-based resins; acrylic resins such as polymethyl (meth)acrylate and polyethyl (meth)acrylate; styrene-based resins such as a polystyrene acrylonitrile-styrene copolymer; polyolefin-based resin having a polyethylene, polypropylene, cyclo-based or norbornene structure, polyolefin-based resins such as an ethylenepropylene copolymer; polyimide-based resins; polyaramide-based resins; polyamideimide-based resins; polyethersulfone-based resins; sulfone-based resins, and the like, and these resins may be used alone or in combination of two or more, but it is not necessarily limited thereto. In addition, considering the excellent transparency, mechanical strength, isotropy, and the like of the film, the substrate may be a polyimide-based resin (which may include a polyamideimide-based resin), but is not necessarily limited thereto.

In one exemplary embodiment, the thickness of the substrate may be 10 to 250 µm, but is not necessarily limited thereto.

In one exemplary embodiment, the hard coating layer is formed on the substrate, and for example, may be formed to be in direct contact with one surface of the substrate or formed to be in direct contact with both surfaces of the substrate.

Hereinafter, a method of manufacturing a flexible window cover film according to one exemplary embodiment described above will be described.

In one exemplary embodiment, the method of manufacturing a flexible window cover film may include applying the hard coating composition including the epoxy polysiloxane resin on a substrate; and curing the hard coating composition applied to form a hard coating layer.

In one exemplary embodiment, the application of the hard coating composition may be performed by any one method selected from die coater, air knife, reverse roll, spray, blade, casting, gravure, spin coating, and the like, or a combined method thereof, but is not necessarily limited thereto.

In one exemplary embodiment, the step of forming a hard coating layer may be photocuring the hard coating composition and then thermal curing, but is not necessarily limited thereto.

In one exemplary embodiment, the thermal curing may be performed at a temperature of 100 to 200° C. for 5 to 20 minutes, but is not necessarily limited thereto.

In addition, in one exemplary embodiment, a step of applying the hard coating composition before the photocuring and then heating the composition to perform a pretreatment may be further included. Here, the pretreatment may be performed at a lower temperature than a thermal curing temperature.

Another exemplary embodiment may provide a flexible display panel including the flexible window cover film described above. More specifically, the flexible display is an image display, and may be various image displays such as a common liquid crystal display, an electroluminescent display, a plasma display, and a field emission display, but is not necessarily limited thereto.

Hereinafter, the present exemplary embodiment will be described in more detail with reference to the examples and the comparative examples. However, the following examples and comparative examples are only one example for describing the present exemplary embodiment in more detail, and do not limit the present exemplary embodiment in any way.

### Method of Measuring Physical Properties

### Weight Average Molecular Weight of Epoxy Polysiloxane Resin

The weight average molecular weights of the epoxy polysiloxane resins obtained in the following examples and comparative examples were measured at a speed of 1 mL/min by using GPC (Waters GPC system, Waters 1515 isocratic HPLC Pump, Waters 2414 Reflective Index detector), connecting 4 columns of Shodex KF-801, 802.5, 803, and 805 available from Waters in series as a GPC column, and using THF as a solvent.

### Pencil Hardness

For the films manufactured in the following examples and comparative examples, according to JIS K5400, a line of 20 mm was drawn at a rate of 50 mm/sec on the film using a load of 750 g, this operation was repeated 5 times or more, and the pencil hardness was measured based on the case in which scratches occurred once or less.

### Indentation Hardness

A hard coating layer was pressed with a certain force of a nano indenter (Fisher, model name: HM2000) load of 30 mN for 15 seconds, crept for 5 seconds, and relaxed for 20 seconds to measure the indentation hardness. The measurement was performed 5 times and the average value thereof was obtained.

### Elastic Recovery Rate

An initial depth, a maximum depth and a depth after relaxation were measured in measuring the indentation hardness, and the elastic recovery rate was calculated from the following Calculation Formula 1:

$$\text{Elastic recovery rate} \left(\%\right) = \left(\text{maximum depth} - \text{depth after relaxation}\right) / \left(\text{maximum depth} - \text{initial depth}\right)$$

### Bending Resistance

Hard coating layers manufactured in the following examples and comparative examples were fixed to a folding tester (YUASA) using an adhesive, based on IEC 62715-6-1. A folding radius was set to a desired value, and an out-folding (outside a coated surface) test was performed by repeating the test 200,000 times at a speed of 60 cycles/min. After completing the test, the number of fine cracks in a folded part of a specimen was observed using a microscope.

### Wear Resistance

A composition for forming an antifouling layer in which an alkoxysilane-based compound containing a perfluorinated group and an alkoxysilane group (Shin-etsu, KY-1905) was diluted at a solid content of 0.1 wt% in a fluorine-based solvent (3M, Novec 7500) was applied on hard coating layers manufactured in the following examples and comparative examples using a Meyer bar #14, was dried at 80° C. for 5 minutes, and was thermally cured at 150° C. for 10 minutes to form a hard coating film having an antifouling layer (thickness: 32 nm) formed thereon, the hard coating film was cut into 7 cm×12 cm and fixed to a jig of a wear resistance measuring device (Kipae E&T Co., Ltd., scratch tester), and a rubber stick having a diameter of 6 mm (Minoan) was mounted on the tip and fixed. A moving distance of 25 mm, a moving speed of 40 rpm, and a load of 0.5 kg were set, the rubber stick was rubbed 1500 times reciprocatingly on the surface of the antifouling layer of the hard coating film, a water contact angle of the worn surface was measured, and when the angle was 95° or more, it was determined as “pass”.

### Scratch Resistance

A composition for forming an antifouling layer in which an alkoxysilane-based compound containing a perfluorinated group and an alkoxysilane group (Shin-etsu, KY-1905) was diluted at a solid content of 0.1 wt% in a fluorine-based solvent (3M, Novec 7500) was applied on hard coating layers manufactured in the following examples and comparative examples using a Meyer bar #14, was dried at 80° C. for 5 minutes, and was thermally cured at 150° C. for 10 minutes to form a hard coating film having an antifouling layer (thickness: 32 nm) formed thereon, the hard coating film was cut into 7 cm×12 cm and fixed to a jig of a wear resistance measuring device (Kipae E&T Co., Ltd., scratch tester), and a steel wool (Nippon Steelwool, Bon Star #0000) was fixed to a 2 cm×2 cm test jig. A moving distance of 40 mm, a moving speed of 40 rpm, and a load of 1 kg were set, the rubber stick was rubbed 2500 times reciprocatingly on the surface of the film, and the surface was observed with the naked eye to determine presence/absence of scratch.

### Example 1

2-(3,4-Epoxycyclohexyl)ethyltrimethoxysilane, 3-glycidyloxypropyltrimethoxysilane, 3-glycidyloxypropylmethyldimethoxysilane, and water were mixed at a ratio of 22.18 g: 1.18 g: 1.10 g: 2.70 g (0.09 mol: 0.005 mol: 0.005 mol: 0.15 mol) to prepare a reaction solution, which was put into a 250 mL 2-neck flask. To the reaction solution, 0.1 mL of tetramethylammonium hydroxide and 100 mL of isopropylalcohol were added, and stirring was performed at 25° C. for 36 hours. Thereafter, layer separation was performed, a product layer was extracted with methylene chloride, moisture was removed from the extract with magnesium sulfate, and the solvent was dried under vacuum to obtain an epoxy polysiloxane resin. The epoxy polysiloxane resin had a weight average molecular weight of 10000 g/mol, as a result of measurement using gel permeation chromatography (GPC).

30 g of the epoxy polysiloxane resin obtained above, 10 g of (3',4'-epoxycyclohexyl)methyl 3,4-epoxycyclohexanecarboxylate, 0.5 g of (4-methylphenyl)[4-(2-methylpropyl)phenyl] iodonium hexafluorophosphate, and 54.5 g of methyl ethyl ketone were mixed to prepare a hard coating composition.

The hard coating composition was applied on a cPI film (colorless polyimide film) having a thickness of 80 µm by a Meyer bar method, and was dried at a temperature of 60° C. for 4 minutes. Irradiation was performed with UV at 1 J/cm² using a high-pressure metal lamp and then curing was performed at a temperature of 120° C. for 10 minutes to form a hard coating layer having a thickness of 5 µm.

### Example 2

A hard coating layer was formed in the same manner as in Example 1, except that the epoxy polysiloxane resin was replaced with a resin having a weight average molecular weight of 10000 g/mol, prepared by mixing 2-(3,4-epoxycyclohexyl)ethyltrimethoxysilane, 3-glycidyloxypropyltrimethoxysilane, 3-glycidyloxypropylmethyldimethoxysilane, methoxy(dimethyl)-n-octylsilane, and water at a ratio of 22.18 g: 1.18 g: 0.55 g: 0.51 g: 2.70 g (0.09 mol: 0.005 mol: 0.0025 mol: 0.0025 mol: 0.15 mol).

### Example 3

A hard coating layer was formed in the same manner as in Example 1, except that the epoxy polysiloxane resin was replaced with a resin having a weight average molecular weight of 8000 g/mol, prepared by mixing 2-(3,4-epoxycyclohexyl)ethyltrimethoxysilane, 3-glycidyloxypropyltrimethoxysilane, 3-glycidyloxypropylmethyldimethoxysilane, methoxy(dimethyl)-n-octylsilane, and water at a ratio of 9.86 g: 11.82 g: 1.10 g: 1.01 g: 2.70 g (0.04 mol: 0.05 mol: 0.005 mol: 0.005 mol: 0.15 mol).

### Comparative Example 1

A hard coating layer was formed in the same manner as in Example 1, except that the epoxy polysiloxane resin was replaced with a resin having a weight average molecular weight of 10000 g/mol, prepared by mixing 2-(3,4-epoxycyclohexyl)ethyltrimethoxysilane and water at a ratio of 24.64 g: 2.70 g (0.1 mol: 0.15 mol).

### Comparative Example 2

A hard coating layer was formed in the same manner as in Example 1, except that the epoxy polysiloxane resin was prepared by mixing 2-(3,4-epoxycyclohexyl)ethyltrimethoxysilane, 3-glycidyloxypropylmethyldimethoxysilane, and water at a ratio of 23.41 g: 1.10 g: 2.70 g (0.095 mol: 0.005 mol: 0.15 mol), and the obtained epoxy polysiloxane resin had a weight average molecular weight of 10000 g/mol.

### Comparative Example 3

A hard coating layer was formed in the same manner as in Example 1, except that the epoxy polysiloxane resin was prepared by mixing 2-(3,4-epoxycyclohexyl)ethyltrimethoxysilane, 3-glycidyloxypropyltrimethoxysilane, methoxy(dimethyl)-n-octylsilane, and water at a ratio of 22.17 g: 1.18 g: 1.01 g: 2.70 g (0.09 mol: 0.005 mol: 0.005 mol: 0.15 mol), and the obtained epoxy polysiloxane resin had a weight average molecular weight of 10000 g/mol.

### Comparative Example 4

A hard coating layer was formed in the same manner as in Example 1, except that the epoxy polysiloxane resin was prepared by mixing 2-(3,4-epoxycyclohexyl)ethyltrimethoxysilane, 3-glycidyloxypropyltrimethoxysilane, 3-glycidyloxypropylmethyldimethoxysilane, and water at a ratio of 19.71 g: 1.18 g: 3.30 g: 2.70 g (0.08 mol: 0.005 mol: 0.015 mol: 0.15 mol), and the obtained epoxy polysiloxane resin had a weight average molecular weight of 10000 g/mol.

The physical properties of the hard coating layers manufactured in Examples 1 to 3 and Comparative Examples 1 to 4 were measured and are shown in the following Table 1.

Table 1

| | | | | | | | | |
|---|---|---|---|---|---|---|---|---|
| | | Example 1 | Example 2 | Example 3 | Comparative Example 1 | Comparative Example 2 | Comparative Example 3 | Comparative Example 4 |
| Composit | (R^{a}SiO_{3/2})ₚ | 0.9 | 0.9 | 0.4 | 1 | 0.95 | 0.9 | 0.8 |
| ion of epoxy polysilo xane resin | (R^{b}SiO_{3/2})_{q} | 0.05 | 0.05 | 0.5 | 0 | 0 | 0.05 | 0.05 |
| | (R^{c}₂SiO)ᵣ | 0.05 | 0.025 | 0.05 | 0 | 0.05 | 0 | 0.15 |
| | (R^{d}₃SiO_{½})ₛ | 0 | 0.025 | 0.05 | 0 | 0 | 0.05 | 0 |
| Physical properti es | Pencil hardness | 6H | 6H | 4H | 6H | 6H | 5H | 3H |
| | Indentation hardness (hv) | 74 | 71 | 70 | 69 | 68 | 62 | 60 |
| | Elastic recovery rate (%) | 86 | 83 | 80 | 83 | 78 | 77 | 75 |
| | Bending resistance | 2.5R Pass | 2.5R Pass | 2.5R Pass | 4R Fail | 3.5R Fail | 3R Fail | 2.5R Pass |
| | Wear resistance | Pass | Pass | Pass | Pass | Pass | Fail | Fail |
| | Scratch resistance | OK | OK | OK | OK | OK | NG | NG |

Referring to Table 1, the hard coating layer of Examples 1 to 3 included 2-(3,4-epoxycyclohexyl)ethyltrimethoxysilane, 3-glycidyloxypropyltrimethoxysilane, 3-glycidyloxypropylmethyldimethoxysilane, and methoxy(dimethyl)-n-octylsilane at a ratio satisfying 0.9 ≤ p+q <1, 0 < r ≤ 0.1, and 0 ≤ s ≤ 0.05, in the preparation of the epoxy polysiloxane resin. Accordingly, the hard coating layers of Examples 1 to 3 had a pencil hardness of 4 H or more, an indentation hardness of 60 hv or more, and an elastic recovery rate of 80% or more, and thus, had surface properties of a very high hardness, and the wear resistance and scratch resistance of the hard coating films including the layers were all excellent as a result of evaluation. Thus, it was confirmed that the surface properties and the durability were significantly improved.

In addition, at the same time, it was confirmed that the hard coating layers of Examples 1 to 3 all had no crack occurrence up to the folding radius of 2.5R, when folding was repeated 200,000 times at a speed of 60 cycles /min after the folding radius was set to a desired value, and thus, had excellent bending resistance, and also had excellent flexibility.

That is, it was confirmed that the hard coating layers of Examples 1 to 3 had a high hardness, excellent surface properties and durability, and excellent bending resistance, and in particular, may implement excellent flexibility and out folding properties so that no crack occurred in out folding.

However, it was confirmed that the hard coating layer of Comparative Example 1 included only 2-(3,4-epoxycyclohexyl)ethyltrimethoxysilane in the preparation of the epoxy polysiloxane resin so that q and r values were 0, and thus, showed poor indentation hardness as compared with Examples 1 to 3, and in particular, had occurrence of a plurality of cracks at a folding radius of 4R, and thus, bending resistance was greatly deteriorated.

In addition, it was confirmed that the hard coating layer of Comparative Example 2 included only 2-(3,4-epoxycyclohexyl)ethyltrimethoxysilane and 3-glycidoxypropylmethyldimethoxysilane in the preparation of the epoxy polysiloxane resin so that the q value was 0, and thus, showed poor indentation hardness and elastic recovery rate as compared with Examples 1 to 3, and had occurrence of a plurality of cracks at a folding radius of 3.5 R, and thus, bending resistance was greatly deteriorated.

In addition, it was confirmed that the hard coating layer of Comparative Example 3 included no 3-glycidyloxypropyl methyldimethoxysilane in the preparation of the epoxy polysiloxane resin so that the r value was 0, and thus, showed poor indentation hardness and elastic recovery rate as compared with Examples 1 to 3, had occurrence of a plurality of cracks at a folding radius of 3R, and thus, bending resistance was greatly deteriorated.

In addition, it was confirmed that the hard coating layer of Comparative Example 4 included 2-(3,4-epoxycyclohexyl)ethyltrimethoxysilane, 3-glycidyloxypropyltrimethoxysilane, and 3-glycidyloxypropylmethyldimethoxysilane at a ratio which does not satisfy 0.9 ≤ p+q < 1 and 0 < r ≤ 0.1 in the preparation of the epoxy polysiloxane resin, and thus, showed significantly deteriorated pencil hardness, indentation hardness, and elastic recovery rate as compared with the hard coating layers of Examples 1 to 3.

Accordingly, since the hard coating layer formed from the hard coating composition according to one exemplary embodiment had a pencil hardness of 4 H or more, an indentation hardness of 60 hv or more, an elastic recovery rate of 80% or more, and no crack occurrence when being repeatedly folded 200,000 times at a speed of 60 cycles/min at a folding radius of 3.5R or less, according to a bending resistance test based on IEC 62715-6-1, by adjusting the content ratios of the constituent components included in the epoxy polysiloxane resin, the hard coating layer may have surface properties such as high hardness, excellent wear resistance, and scratch resistance, while also implementing excellent flexibility and out folding properties at an appropriate level to be used in a flexible display panel.

A hard coating layer formed from a hard coating composition for a flexible window cover film as one exemplary embodiment has excellent surface properties of high hardness while also maintaining excellent flexibility so to be appropriate for use in a flexible display panel.

In addition, the hard coating layer according to one exemplary embodiment may implement excellent physical properties such as significantly improved pencil hardness, indentation hardness, elastic recovery rate, and bending resistance, simultaneously.

Hereinabove, although the hard coating composition for a flexible window cover film, the hard coating layer obtained therefrom, and the flexible window cover film including the same have been described in the present exemplary embodiment by specific matters and limited examples, these have been provided only for assisting in the entire understanding of the present exemplary embodiment, and the present exemplary embodiment is not limited to the above examples. Various modifications and changes may be made by those skilled in the art to which the present exemplary embodiment pertains from this description.

1. A hard coating composition for a flexible window cover film comprising an epoxy polysiloxane resin including a unit represented by the following Chemical Formula 1: 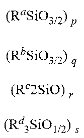
wherein R^{a} is an alicyclic epoxy group or an alkyl group substituted by an alicyclic epoxy group, R^{b} is any one group selected from a glycidyl group, an alkyl group, an alkenyl group, an alkynyl group, an acryl group, a methacryl group, and an aryl group, or an alkyl group substituted by any one or two or more groups selected from those groups, and R^{c} and R^{d} are independently of each other any one group selected from an alicyclic epoxy group, a glycidyl group, an alkyl group, an alkenyl group, an alkynyl group, an acryl group, a methacryl group, and an aryl group, or an alkyl group substituted by any one or two or more groups selected from those groups, and
the substituted alkyl group has a functional group which is any one selected from an amino group, a halogen, a mercapto group, an ether group, an ester group, a carbonyl group, a carboxyl group, a nitro group, a sulfone group, a hydroxyl group, a urethane group, and oxetane group, or a combination thereof, and
$$0 {}_{\cdot } 9 \leq \text{p+q} \text{<1}$$
$$0 < \text{r} \leq \text{0} \text{.} 1 , \text{and}$$
$$0 \leq \text{s} \leq \text{0} .05.$$
.

2. The hard coating composition for a flexible window cover film of claim 1, wherein in Chemical Formula 1, p is 0.5 or more and less than 1, and p is more than 0 and 0.49 or less.

3. The hard coating composition for a flexible window cover film of claim 1, wherein the epoxy polysiloxane resin including a unit represented by the following Chemical Formula 1 satisfies:
$$0.95 \leq \text{p+q} \text{<1,} \text{and}$$
$$0 < \text{r} \leq \text{0} .05.$$
.

4. The hard coating composition for a flexible window cover film of claim 1, wherein the epoxy polysiloxane resin has a weight average molecular weight (Mw) of 2,000 to 40,000 g/mol.

5. The hard coating composition for a flexible window cover film of claim 1, further comprising an epoxy compound having an alicyclic epoxy group.

6. The hard coating composition for a flexible window cover film of claim 5, wherein the epoxy compound has an epoxy equivalent of 150 g/eq or less.

7. The hard coating composition for a flexible window cover film of claim 5, wherein the epoxy compound is a compound represented by the following Chemical Formula 2 or 3: 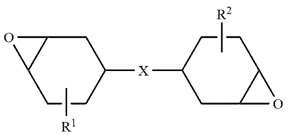 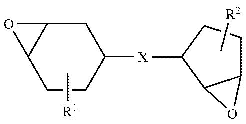
wherein R¹ and R² is independently of each other hydrogen; or a linear or branched alkyl group having 1 to 5 carbon atoms, and X is a direct bond; a carbonyl group; a carbonate group; an ether group; a thioether group; an ester group; an arylene group; an amide group; a linear or branched alkylene group, alkylidene group, or alkoxylene group having 1 to 18 carbon atoms; a cycloalkylene group or a cycloalkylidene group having 3 to 6 carbon atoms; or a group formed by two or more selected therefrom being linked to each other.

8. The hard coating composition for a flexible window cover film of claim 5, wherein the epoxy compound is comprised at 1 to 60 parts by weight with respect to 100 parts by weight of the epoxy polysiloxane resin.

9. The hard coating composition for a flexible window cover film of claim 5, further comprising a photoinitiator and a thermal initiator including a compound represented by the following Chemical Formula 6: 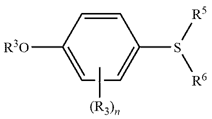
wherein R³ is hydrogen, an alkoxycarbonyl group having 1 to 4 carbon atoms, an alkylcarbonyl group having 1 to 4 carbon atoms, or an arylcarbonyl group having 6 to 14 carbon atoms, R⁴ is independently of each other hydrogen, a halogen, or an alkyl group having 1 to 4 carbon atoms, n is 1 to 4, R⁵ is an alkyl group having 1 to 4 carbon atoms or an aralkyl group having 7 to 15 carbon atoms which is substituted by an alkyl group having 1 to 4 carbon atoms, R⁶ is an alkyl group having 1 to 4 carbon atoms, and X is SbF₆, PF₆, AsF₆, BF₄, CF₃SO₃, N(CF₃SO₂)₂, or N(C₆ F₅)₄.

10. The hard coating composition for a flexible window cover film of claim 1, further comprising inorganic particles which are any one selected from inorganic nanoparticles and surface-treated inorganic nanoparticles, or a mixture thereof.

11. The hard coating composition for a flexible window cover film of claim 10, wherein the inorganic particles have an average particle diameter of 100 nm or less.

12. The hard coating composition for a flexible window cover film of claim 10, wherein the inorganic particles are any one selected from silica and alumina, or a mixture thereof.

13. The hard coating composition for a flexible window cover film of claim 10, wherein the inorganic particles are comprised at 0.01 to 10 parts by weight with respect to 100 parts by weight of the epoxy polysiloxane resin.

14. A hard coating layer for a flexible window cover film, which has a pencil hardness of 4 H or more, an indentation hardness of 60 hv or more, an elastic recovery rate of 80% or more, and no crack occurrence when being repeatedly folded 200,000 times at a speed of 60 cycles/min at a folding radius of 3.5 R or less, according to a bending resistance test based on IEC 62715-6-1.

15. The hard coating layer for a flexible window cover film of claim 14, wherein the hard coating layer is formed from the hard coating composition for a flexible window cover film of claim 1.

16. The hard coating layer for a flexible window cover film of claim 15, wherein the hard coating layer is obtained by photocuring and thermal curing of the hard coating composition for a flexible window cover film.

17. A flexible window cover film comprising:
a substrate; and
the hard coating layer for a flexible window cover film of claim 14 formed on one or both surfaces of the substrate.
